(19) United States
(12) Patent Application Publication
(10) Pub. No.: US 2024/0351713 A1
(43) Pub. Date: Oct. 24, 2024

(54) POWER SUPPLY SYSTEM, FLOATING BODY, ESTIMATION METHOD, AND ESTIMATION PROGRAM

(71) Applicant: Nippon Telegraph and Telephone Corporation, Tokyo (JP)

(72) Inventors: Go ITAMI, Musashino-shi, Tokyo (JP); Tsuneko KURA, Musashino-shi, Tokyo (JP); Hiroshi MATSUBARA, Musashino-shi, Tokyo (JP); Jun KATO, Musashino-shi, Tokyo (JP)

(21) Appl. No.: 18/701,729

(22) PCT Filed: Nov. 2, 2021
(86) PCT No.: PCT/JP2021/040375

§ 371 Date: Apr. 16, 2024

(51) Int. Cl. B64U 50/38; B60L 53/12; B60L 53/30; B63B 35/44; B64U 101/00; G05D 1/656; G05D 105/80; H02J 50/12; H02J 50/90

(52) U.S. Cl. CPC B64U 50/38; B60L 53/12; B60L 53/30; B63B 35/44; G05D 1/656; H02J 50/12; H02J 50/90; B60L 2200/10; B64U 2101/00; G05D 2105/80

(57) ABSTRACT

A power feeding system 1 includes a floating body 11 having power and a control function and
an unmanned aerial vehicle 21 that observes environmental information using the floating body 11 as a base, in which the floating body 11 includes a power feeding device 12 that moves in a space below a top surface of the floating body 11 with reference to one of a plurality of planes arranged in a lattice shape on the floating body 11, roughly specifies a position of the unmanned aerial vehicle 21 in two dimensions based on a reflectance of an emitted radio wave, estimates and calculates a power feeding position of the unmanned aerial vehicle 21 based on a reflectance of an output light beam reflected on a reflector attached to a back surface corresponding to a power receiving position of the unmanned aerial vehicle 21, and feeds the unmanned aerial vehicle 21 with power at the power feeding position.

### TECHNICAL FIELD

The present invention relates to a power feeding system, a floating body, an estimation method, and an estimation program.

### BACKGROUND ART

A current main technology for monitoring of global environments is satellite remote sensing, and there are a sensing method using a microwave band synthetic aperture radar and a sensing method using visible light and infrared rays.

In those methods, it is possible to grasp a spatial distribution and temporal transition of a ground surface, deforestation damage, ozone holes, clouds, aerosols, and harmful gases (NO₂, SO₂, etc.) by observing a change in scattering/reflection spectra of radio waves or light incident on the earth. These kinds of information can be useful for weather predictions, environmental protection, disaster prevention, and the like.

However, the above methods are a combination of image processing of a captured image and other preliminary information or statistical techniques, mostly are just involved with estimation that does not rely on actual data, and do not have a sufficient sensing resolution in the vertical direction due to the nature of the measurement method, and therefore, there is room for significant improvement in reliability and sensing resolution of the data.

On the other hand, environmental monitoring of the ground is also performed. Periodic observation based on actual data such as air pollution, human flow measurement, CO₂ concentration, temperature, and humidity is performed, and data reliability can be secured by using actual data from which observation conditions can be grasped in detail. However, there is a problem that the number of measurement points and the measurement range are limited.

Similarly, environmental monitoring activities for the oceans have also been performed, and fixed point observation using a ship or a buoy, observation in a wide range using a sea current, measurement of the temperature in the sea in a deep part by changing the density of the buoy, and the like are performed. However, there is still sufficient room for future studies, such as the fact that installation and replacement of the buoy must be manual work, the fact that the number of measurement points is limited for the same reason, the fact that it is difficult to recover a damaged buoy, and the limit of the measurement engine due to the battery life.

Thus, by combining satellite data with terrestrial and marine data, it can be expected to secure spatial and temporal coverage and high reliability of the data. That is, by linking an autonomous sensor network that is constructed with the concept of the Internet of Things (IoT) and can be placed anywhere on the earth to a satellite remote sensing technology, sensing can be advanced further as a technology for monitoring the entire globe.

For example, various pieces of information measured by various IoT sensors are collectively transmitted to a satellite, and an enormous amount of information is collectively transmitted to a ground station together with information on the satellite sensing conditions, so that it is possible to create 3D mapping information with high data reliability in which specific sensor information obtained by combining satellite data with terrestrial and marine data is reflected.

In order to realize global environment monitoring by the IoT sensor network utilizing satellites as described above, it is essential to enhance the hardware base that enables autonomous operations of a sensor network arranged in any environment in an enormous amount.

In particular, in recent years, services using unmanned aerial vehicles (hereinafter, drones) have attracted attention from the viewpoint of technological advancement and automation at the time of disaster prediction and recovery. In order to autonomously operate a drone for a long time, a mechanism for feeding power from the outside is required. Therefore, an automatic charging technology by wireless power transmission from a drone has been developed (Non Patent Literature 1 and Non Patent Literature 2).

### CITATION LIST

### Non Patent Literature

Non Patent Literature 1: A. Kurs, and five others, “Wireless Power Transfer via Strongly Coupled Magnetic Resonances”, Science, Vol 317, Issue 5834 Jul. 6, 2007, pp. 83-86
Non Patent Literature 2: Hiroshi Hamada, “Wireless Power Transmission (WPT) System for Drone Charging”, Journal of the Institute of Electronics, Information and Communication Engineers, Vol. 103, No. 10, October 2020, pp. 1037-1042

### SUMMARY OF INVENTION

### Technical Problem

Operation of hardware on which a sensor device such as an industrial drone is mounted is generally more difficult in operation on the sea than on the ground. Technologies for developing various services have been studied assuming ground use, but technologies assuming marine use have been studied with an area extremely limited, or an outline of a platform cannot be designed and has no prospect of examination. In order to realize a practical global-scale marine observation platform, it is necessary to consider autonomous operations, automatic operations, and environmental protection.

In a case where a drone is operated on a sea, the drone is taken off from or landed on a floating body (hereinafter, the station) installed on the sea, and can sense environmental information from the sea. However, the drone operation over the sea has a problem that it is difficult to adjust the position of the drone for efficiently feeding power when contactless power feeding is performed for the drone that has taken off from the station installed on the sea to perform sensing.

The present invention has been made in view of the above circumstances, and an object of the present invention is to provide a technology capable of realizing efficient and highly accurate power feeding for an unmanned aerial vehicle that has taken off from a floating body to perform sensing.

### Solution to Problem

A power feeding system according to an aspect of the present invention is a power feeding system including a floating body having power and a control function, and an unmanned aerial vehicle that observes environmental information using the floating body as a base, in which the floating body includes a power feeding device that moves in a space below a top surface of the floating body with reference to one of a plurality of planes arranged in a lattice shape on the floating body, roughly specifies a position of the unmanned aerial vehicle in two dimensions based on a reflectance of an emitted radio wave, estimates and calculates a power feeding position of the unmanned aerial vehicle based on a reflectance of an output light beam reflected on a reflector attached to a back surface corresponding to a power receiving position of the unmanned aerial vehicle, and feeds the unmanned aerial vehicle with power at the power feeding position.

The floating body according to an aspect of the present invention is a floating body that functions as a base of an unmanned aerial vehicle that observes environmental information, and includes a power feeding device that moves in a space below a top surface of the floating body with reference to one of a plurality of planes arranged in a lattice shape on the floating body, roughly specifies a position of the unmanned aerial vehicle in two dimensions based on a reflectance of an emitted radio wave, estimates and calculates a power feeding position of the unmanned aerial vehicle based on a reflectance of an output light beam reflected on a reflector attached to a back surface corresponding to a power receiving position of the unmanned aerial vehicle, and feeds the unmanned aerial vehicle with power at the power feeding position.

An estimation method according to an aspect of the present invention is an estimation method for estimating a power feeding position, and, in a floating body functioning as a base of an unmanned aerial vehicle configured to observe environmental information, the estimation method enables a power feeding device that moves in a space below a top surface of the floating body with reference to one of a plurality of planes arranged in a lattice shape on the floating body and feeds the unmanned aerial vehicle with power to perform a step of roughly specifying a position of the unmanned aerial vehicle in two dimensions based on a reflectance of an emitted radio wave, and a step of estimating and calculating a power feeding position of the unmanned aerial vehicle based on a reflectance of an output light beam reflected on a reflector attached to a back surface corresponding to a power receiving position of the unmanned aerial vehicle.

An estimation program according to an aspect of the present invention is an estimation program for estimating a power feeding position, and, in a floating body functioning as a base of an unmanned aerial vehicle configured to observe environmental information, the estimation program causes a computer of a power feeding device that moves in a space below a top surface of the floating body with reference to one of a plurality of planes arranged in a lattice shape on the floating body and feeds the unmanned aerial vehicle with power to perform a procedure of roughly specifying a position of the unmanned aerial vehicle in two dimensions based on a reflectance of an emitted radio wave, and
a procedure of estimating and calculating a power feeding position of the unmanned aerial vehicle based on a reflectance of an output light beam reflected on a reflector attached to a back surface corresponding to a power receiving position of the unmanned aerial vehicle.

### Advantageous Effects of Invention

According to the present invention, it is possible to provide a technology capable of realizing efficient and highly accurate power feeding for an unmanned aerial vehicle that has taken off from a floating body to perform sensing.

### BRIEF DESCRIPTION OF DRAWINGS

FIG. 1 is a diagram illustrating a configuration example of a power feeding system.

FIG. 2 is a diagram illustrating the top surface of a station.

FIG. 3 is a diagram illustrating a configuration example of a power feeding device.

FIG. 4 is a diagram illustrating an example of movement of the power feeding device.

FIG. 5 is a diagram illustrating an example of movement of the power feeding device in a power feeding zone.

FIG. 6 is a diagram illustrating a configuration example of a frame with a sheet.

FIG. 7 is a view illustrating a configuration example of a power feeding system.

FIG. 8 is a diagram illustrating a configuration example of a power feeding device and a conditioner.

### DESCRIPTION OF EMBODIMENTS

Embodiments of the present invention will be described below with reference to the drawings. In the drawings, the same parts are denoted by the same reference signs, and the description thereof is omitted.

### Overview

Drone operation on a sea has the following problems.

A first problem is that, when a drone that has taken off from a station installed on the sea and performs sensing is subject to contactless power feeding at the station, it is difficult to adjust a position of the drone for efficiently feeding power.

A second problem is that, similarly to the first problem, a drone that is subject to contactless power feeding at a station moves or falls from the station due to wind, rain, waves, or the like.

A third problem is that, similarly to the first problem, since a drone that is subject to contactless power feeding at a station is equipped with a power receiving device, the payload is compressed, and thus sufficient sensors cannot be mounted in the drone.

A fourth problem is that, similarly to the first problem, when a drone that is subject to contactless power supply at a station lands at a power feeding position, the power feeding efficiency may be significantly reduced due to metal foreign substances, rainwater, or the like staying between the drone and the power feeding device.

In order to solve the above problems, the present invention discloses a technology related to efficiency of power feeding alignment, prevention of movement of a drone due to wind, rain, waves, or the like, reduction of the payload of the power receiving device of the drone, and prevention of metal foreign substances, rainwater, or the like from staying between the drone and the power feeding device.

### System Configuration

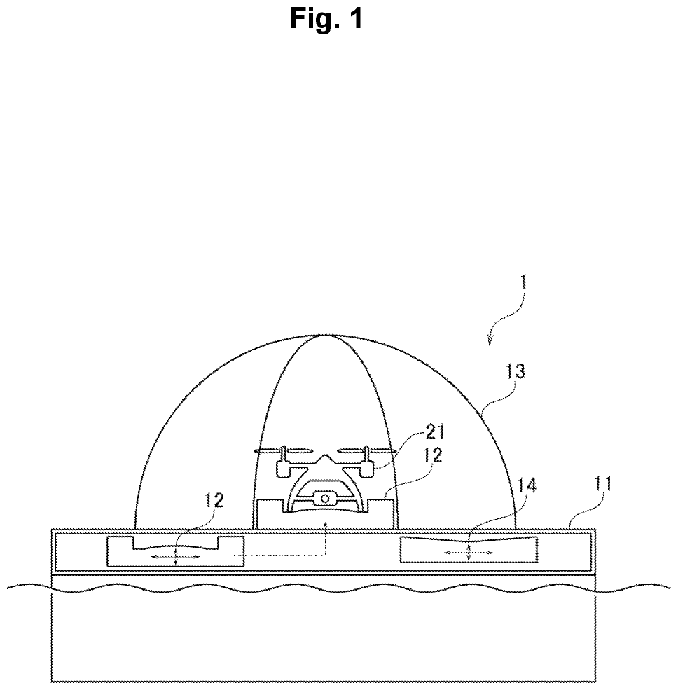

FIG. 1 is a diagram illustrating a configuration example of a power feeding system 1 according to the present embodiment. The power feeding system 1 includes a marine station (floating body) 11 having power and a control function, and a drone (unmanned aerial vehicle) 21 that observes marine environmental information using the station 11 as a base.

As shown in FIG. 1, the station 11 includes a power feeding device 12 that moves to the up, down, left, and right sides in the station 11 to supply power to the drone 21, a frame with a windshield sheet 13 that prevents the drone 21 from moving in position due to wind, rain, waves, or the like on the station 11, and a conditioner (air conditioning device) 14 that moves to the up, down, left, and right sides in the station 11 to prevent metal foreign substances, rainwater, or the like from staying on the power feeding device 12.

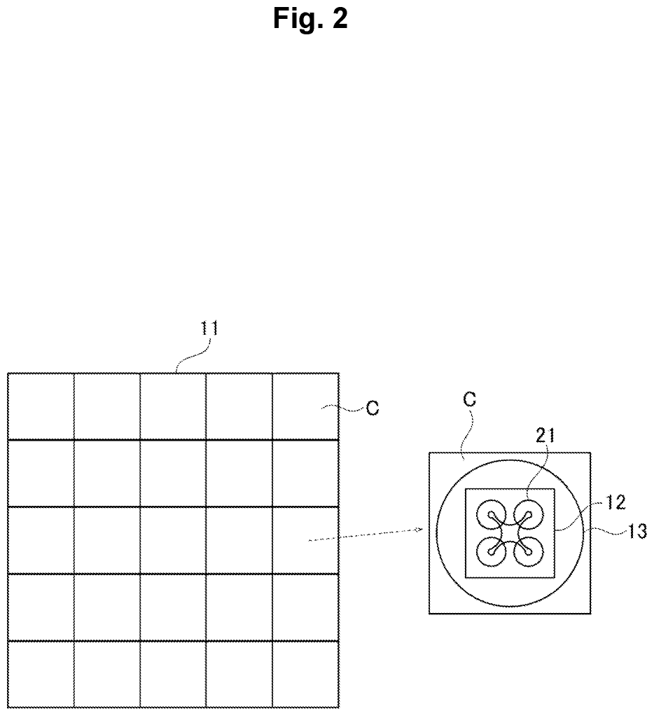

FIG. 2 is a diagram illustrating the top surface of the station 11. The station 11 has a plurality of planes (referred to as, cells below) C arranged in a lattice shape. The drone 21 lands on any one of the plurality of cells C having a lattice shape, is covered with the frame with a sheet 13, and is fed with power by the power feeding device 12.

### Example 1

Example 1 is about a technique for improving efficiency of power feeding alignment. This technique aims to efficiently and precisely align the power feeding device 12 with a position of the drone 21.

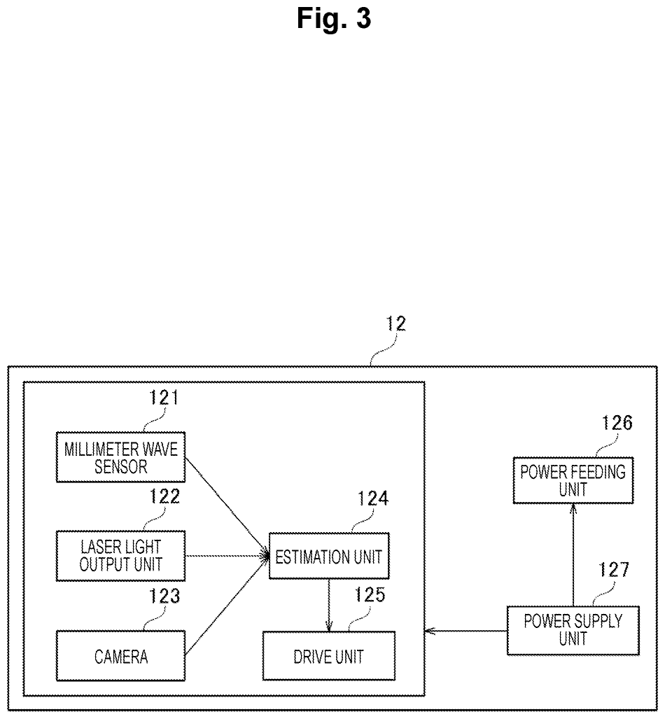

In order to realize this technique, the power feeding device 12 has the configuration illustrated in FIG. 3. As illustrated in FIG. 3, the power feeding device 12 includes a millimeter wave sensor 121 that emits millimeter waves, a laser light output unit 122 that emits laser light, a camera 123 that captures an image of the top surface of the power feeding device 12, an estimation unit 124 that estimates a power feeding position, a drive unit 125 that drives the power feeding device 12, a power feeding unit 126 that performs contactless power feeding, and a power supply unit 127 that supplies power to each unit.

The technology of Example 1 includes two techniques.

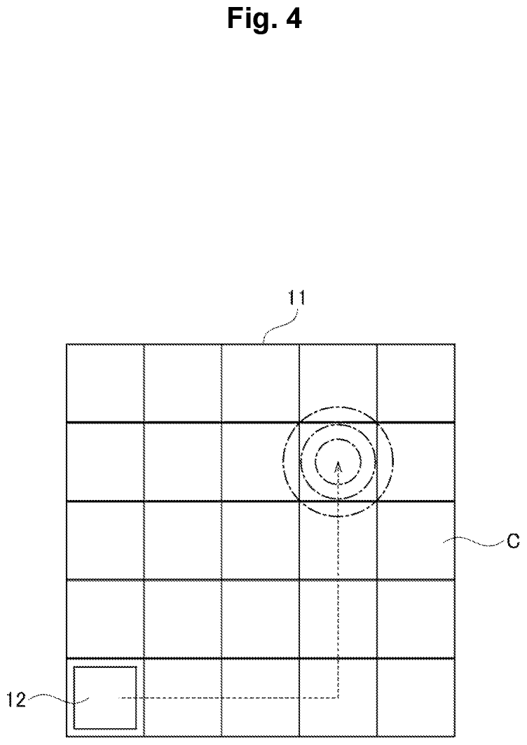

The first is a technique of roughly grasping a position of the drone 21 and causing the power feeding device 12 to get closer thereto. The power feeding device 12 maps the reflection intensity of a radio wave in a scanning manner on the station 11 by using the millimeter wave sensor 121. Then, the estimation unit 124 estimates the optimum power feeding position (appropriate cell C) using the reflection intensity distribution. Then, the drive unit 125 moves the power feeding device 12 to the appropriate cell C. The power feeding device 12 that has moved to the appropriate cell C floats up from the storage layer in storage by a lift. As a result, as illustrated in FIG. 4, the power feeding device 12 can be brought close to the drone 21 in units of cells.

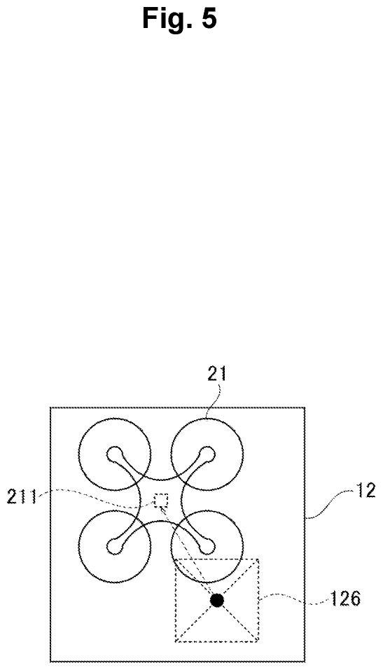

The second is a technique of estimating the optimum power feeding position for the drone 21 with high accuracy and optimizing power feeding efficiency. As illustrated in FIG. 5, the estimation unit 124 estimates the position where the reflection intensity of laser light emitted from the laser light output unit 122 is maximized by using a mirror (reflector) 211 installed at the center of the back surface corresponding to the power receiving unit of the drone 21. Then, the power feeding unit 126 adjusts the power feeding position such that the center of the power feeding zone is located at the estimated position. The position of the power feeding zone in the power feeding unit 126 may be adjusted, or the position of the power feeding unit 126 or the power feeding device 12 may be adjusted. As a result, the power feeding position can be estimated with high accuracy, and the power feeding efficiency can be optimized.

At this time, the power feeding device 12 can also perform position estimation to exclude a position where moisture and foreign matters are captured by further using image information of the top surface of the power feeding device 12 captured by the camera 123. As a result, the power feeding position can be estimated more appropriately.

That is, the power feeding device 12 moves in the space below the top surface of the station 11 with one cell C among the plurality of cells C arranged in a lattice shape on the station 11 as a reference, roughly specifies the position of the drone 21 in two dimensions based on the reflectance of emitted radio waves, estimates and calculates the power feeding position of the drone 21 based on the reflectance of the output light beam reflected on the mirror 211 attached to the back surface corresponding to the power receiving position of the drone 21, and feeds the drone 21 with power at the power feeding position.

As described above, the station 11 according to Example 1 includes the power feeding device 12 that estimates an approximate value of the power feeding position for determining an appropriate cell for feeding by using the millimeter wave sensor, and performs position adjustment of the power feeding position for optimizing the power feeding position by fine position adjustment using laser light, and thus the power feeding device 12 can be efficiently and accurately aligned with the position of the drone 21.

Note that the processing of the estimation unit 124 is executed by a computer mounted in the power feeding device 12. The computer includes a CPU, a memory, a storage, and the like. In this computer, the processing of the estimation unit 124 is realized by the CPU executing a program for the estimation unit 124 loaded on the memory. The program for the estimation unit 124 can be recorded in a computer-readable recording medium such as an HDD, an SSD, a USB memory, a CD, or a DVD.

### Example 2

Example 2 is about a technique for preventing movement of a drone due to wind, rain, waves, or the like.

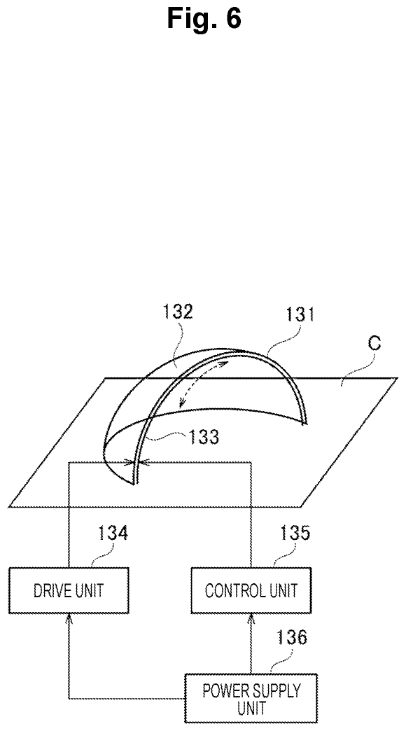

In order to realize this technique, the frame with a sheet 13 has the configuration illustrated in FIG. 6. As shown in FIG. 6, the frame with a sheet 13 includes a pair of frames 131 having a semicircular shape, a windshield sheet 132 provided between the frames 131 and the surface of the cell C, an electromagnet 133 attached to the surface of the frames 131, a drive unit 134 that raises the frames 131 from the surface of the cell C, a control unit 135 that turns on and off a current for the electromagnet 133, and a power supply unit 136 that supplies power to the drive unit 134 and the control unit 135. Note that FIG. 6 illustrates only one of the pair of frames 131.

The frame with a sheet 13 is installed for each of the cells C in a lattice shape. After the drone 21 lands on a cell C, the drive unit 134 lifts the left and right frames 131 each having a symmetrical semicircular shape from the left and right portions in the cell C while rotating the left and right frames. Then, the control unit 135 applies a current to each of the electromagnets 133 of the left and right frames 131. As a result, the two frames 131 are bonded to each other on the surface of the cell C by an attractive force of the electromagnets or the like, and the windshield sheet 132 covering the frames 131 protects the drone 21 positioned inside the frames from the external environment such as wind.

When the power feeding is completed and the drone 21 takes off from the station 11, the control unit 135 stops the current flowing through the electromagnets 133 to release the bonding state. Then, the drive unit 134 stores the left and right frames 131 within the plane of the cell C by performing an operation opposite to that performed to lift the frames 131.

That is, in the frame with a sheet 13, the pair of frames 131 appears from the left and right sides of the plane of the cell C arranged in a lattice shape on the station 11 and bonds to each other by the force of the electromagnets, and when the drone 21 completes power feeding and takes off, the frames 131 are separated to the left and right due to release of the force of the electromagnets and stored in the station 11.

As described above, the station 11 according to Example 2 includes the frame with a sheet 13 in which the right and left frames 131 having a semicircular shape are lifted while rotating and are bonded to each other by the force of the electromagnets 133, and thus, it is possible to realize prevention of movement of the drone 21 due to wind, rain, waves, or the like.

### Example 3

Example 3 is about a technique for reducing the payload of the power receiving device of the drone 21.

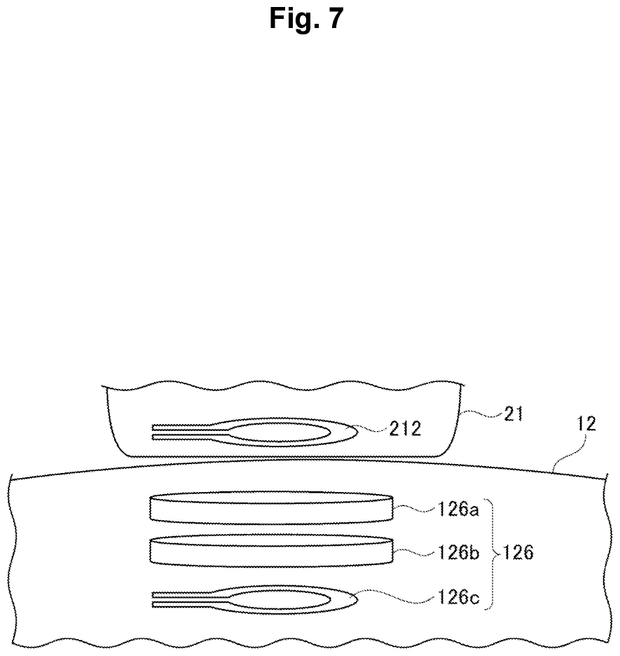

In order to realize this technique, the power receiving device of the drone 21 and the power feeding device 12 of the station 11 have the configuration illustrated in FIG. 7. As illustrated in FIG. 7, the power receiving device of the drone 21 includes only the power receiving coil 212 in the power feeding system of the magnetic field resonance transmission system. The power feeding unit 126 of the power feeding device 12 includes a resonator 126a on the power receiving side, a resonator 126b on the power transmitting side (power feeding side), and a power transmission coil 126c.

In a case where a magnetic field resonance transmission method is assumed, in a power feeding system of the magnetic field resonance transmission method, the power transmitting side and the power receiving side each need a coil having a function of generating a magnetic field and a resonator used for improving power transmission efficiency. At this point, while the coil has a relatively lightweight structure, the resonator often has a relatively heavy structure because ferrite or the like is used, and thus, pressure of the payload of the drone 21 is expected.

Therefore, in order to avoid pressure of the payload caused by mounting of the resonator, the resonator on the power receiving side is mounted on the power transmitting side, thereby reducing the weight of the power receiving device of the drone 21 and securing the payload. In the magnetic field resonance system, it is known that transmission efficiency is sensitive to a positional deviation in the transmission direction (vertical direction), but is strong to a positional deviation in the horizontal direction, and since the positions of three elements other than the coil on the power receiving side among four elements (coils and resonators for power reception and power transmission) used for transmission are fixed, even when the installation position of the drone 21 is deviated, the transmission efficiency can be adjusted only by position adjustment of a relatively lightweight coil, and the power feeding efficiency adjustment is simplified. In addition, since the amount of power used for position adjustment may be also small, power saving is achieved.

That is, in the power feeding system using the magnetic field resonance system between the drone 21 and the station 11, the power feeding device 12 physically mounts the resonator on the power receiving side, which should originally be mounted in the drone 21, on its own device that is on the power transmitting side. When the drone 21 is arranged at the power feeding position, the resonator on the power receiving side acts as a resonator of the drone 21 on the power receiving side in a pseudo manner on the circuit mechanism.

As described above, since the station 11 according to Example 3 includes the resonator on the power receiving side, not the drone 21, the power receiving device of the drone 21 can be reduced in weight, and the payload of the power receiving device of the drone 21 can be reduced.

### Example 4

Example 4 is about a technique for preventing metal foreign substances, rainwater, and the like from staying between the power receiving device of the drone 21 and the power feeding device 12. This technique includes a spherical power feeding surface of the power feeding device 12 and an absorption function, a drying function, an air blowing function, and a suction function of the conditioner 14.

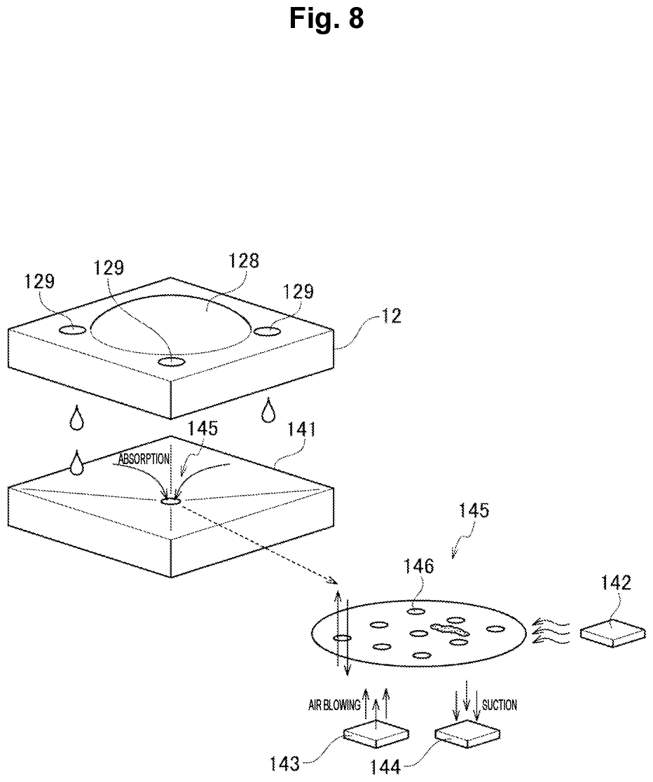

Specifically, the power feeding device 12 and the conditioner 14 have the configuration illustrated in FIG. 8. As illustrated in FIG. 8, the power feeding device 12 includes a spherical power feeding surface 128 formed in a spherical shape on the top surface of the power feeding device 12, and an intake 129 for absorbing residual substance formed at an edge of the spherical power feeding surface 128. The conditioner 14 includes an absorption function section 141 that absorbs residual substances, a drying function section 142 that dries the residual substances, an air blowing function section 143 that blows air to residual substances, and a suction function section 144 that sucks residual substances.

Due to the spherical structure of the surface of the spherical power feeding surface 128, residual substances such as water staying on the top surface of the power feeding device 12 flows down through the intake 129. As a result, since the residual substances on the power feeding device 12 are removed, a stable power feeding environment can be secured.

Similarly to the power feeding device 12, the conditioner 14 is a structure that moves and stops in units of cells arranged in a lattice shape on the station 11, and operates in such a manner that the conditioner is vertically connected to the bottom of the power feeding device 12 floating for power feeding when used.

The above four functions of the conditioner 14 are implemented via the power feeding device 12. The absorption function section 141 has a mechanism for allowing residual substances flowing down through the intake 129 of the power feeding device 12 to flow into an intake 145 at the center due to a gently inclined structure of the surface of the conditioner 14.

The drying function section 142 releases heat to the inside of the conditioner 14 to raise the temperature of the air inside the conditioner, thereby drying the residual substance recovered by the absorption function section 141 inside the conditioner 14 to remove the moisture contained in the residual substance. The release of heat is performed through ventilation ports of the power feeding device 12.

Then, the air blowing function section 143 and the suction function section 144 function to remove residual substances on the surface from the station 11. Large residual substances are removed by air blowing by the air blowing function section 143. Small residual substances are removed by suction by the suction function section 144. The air blowing and suction are performed through ventilation ports 146 formed in the intake 145 on the surface of the conditioner 14. Countless ventilation ports 146 are formed on the surface of the conditioner 14, through which output of air blowing and suction can be controlled. Air blowing and suction are performed through the ventilation ports of the power feeding device 12.

That is, the conditioner 14 includes the absorption function section (surface structure) 141 that moves in the space below the top surface of the station 11 with one cell C among the plurality of cells C arranged in a lattice shape on the station 11 as a reference and allows a residual substance flowing down from the intake 129 of the power feeding device 12 to flow into the center of the surface, the drying function section (drying function) 142 that dries the moisture contained in the residual substance through the ventilation ports of the power feeding device 12, and the air blowing function section (removal function) 143 that removes the moisture-dried residual substance by blowing air through the countless ventilation ports 146 formed on the surface of the conditioner 14 and the ventilation ports of the power feeding device 12, and the suction function section (removal function) 144 that removes the moisture-dried residual substance by suction through the countless ventilation ports 146 formed on the surface of the conditioner 14 and the ventilation ports of the power feeding device 12.

As described above, the station 11 according to Example 4 causes the residual substance flowing down from the intake 129 of the power feeding device 12 to flow into the center of the surface, dries the moisture contained in the residual substance, and removes the moisture-dried residual substance by air blowing or suction, and thus it is possible to prevent metal foreign substances, rainwater, and the like from staying between the power receiving device of the drone 21 and the power feeding device 12 of the station 11.

### Example Applications

The power feeding system 1 described in the present embodiment is a marine observation system that performs power feeding on the seas and observes environmental information on the seas. The power feeding system 1 can also be applied to a case in which power is fed on a lake or the like in addition to a case in which power is fed on the seas. In addition, the power feeding system 1 can also be applied to a case in which a drone takes off from the station 11 on the sea and observes environmental information on land or the like, in addition to a case of observation of environmental information on the seas.

The power feeding system 1 described in the present embodiment is applicable to technical fields such as marine IoT sensing and satellite remote sensing. In addition to the application to the oceans, it can also be used for terrestrial IoT solutions. For example, it is possible to enhance the system in a sustainable manner by applying the technology to an automated platform of logistics utilizing drones and an automated driving technology such as a future aerial taxi service.

### Effects

According to the present invention, it is possible to realize smooth, stable, and highly efficient power feeding of a drone that takes off from and lands on a station to perform sensing. By putting this technology into practical use, it is possible to autonomously and semi-permanently collect useful information as described above with little manpower. Monitoring information with high added value can be created by combining and linking information transmitted from the IoT sensors and satellite data. In addition, problems arising from aging of workers in fishing and agricultural industries, manpower shortage, and technology succession can also be reduced by assisting the work based on information obtained remotely as described above.

### REFERENCE SIGNS LIST

1 Power feeding system
11 Station (floating body)
12 Power feeding device
13 Frame with a sheet
14 Conditioner (air conditioner)
21 Drone (unmanned aerial vehicle)
121 Millimeter wave sensor
122 Laser light output unit
123 Camera
124 Estimation unit
125 Drive unit
126 Power feeding unit
126a Resonator on the power receiving side
126b Resonator on the power transmitting side (power feeding side)
126c Power transmission coil
127 Power supply unit
128 Spherical power feeding surface
129 Intake
131 Frame
132 Sheet
133 Electromagnet
134 Drive unit
135 Control unit
136 Power supply unit
141 Absorption function section (surface structure)
142 Drying function section (drying function)
143 Air blowing function section (removal function)
144 Suction function section (removal function)
145 Intake
146 Ventilation port
211 Mirror (reflector)
212 Power receiving coil

1. A power feeding system comprising:
a floating body having power and a control function; and
an unmanned aerial vehicle configured to observe environmental information using the floating body as a base, wherein
the floating body includes
a power feeding device configured to move in a space below a top surface of the floating body with reference to one of a plurality of planes arranged in a lattice shape on the floating body, roughly specify a position of the unmanned aerial vehicle in two dimensions based on a reflectance of an emitted radio wave, estimate and calculate a power feeding position of the unmanned aerial vehicle based on a reflectance of an output light beam reflected on a reflector attached to a back surface corresponding to a power receiving position of the unmanned aerial vehicle, and feed the unmanned aerial vehicle with power at the power feeding position.

2. The power feeding system according to claim 1, wherein
the floating body further includes
a frame with a sheet in which a pair of frames appears from the plane and bonds to each other by a force of an electromagnet, and are separated from each other due to release of the force of the electromagnet.

3. The power feeding system according to claim 1, wherein
the power feeding device includes
a resonator configured to act as a resonator on a power receiving side in a pseudo manner on a circuit mechanism at the time of power feeding to the unmanned aerial vehicle in the power feeding system of a magnetic field resonance system between the unmanned aerial vehicle and the floating body.

4. The power feeding system according to claim 1, wherein
the floating body includes:
an air conditioner having a surface structure that allows movement in a space below the top surface of the floating body with reference to one plane and allows a residual substance flowing down from an intake of the power feeding device to flow into a center of a surface, a drying function that enables moisture contained in the residual substance to be dried through a ventilation port of the power feeding device, and a removal function that enables the moisture-dried residual substance to be removed by air blowing or suction through the ventilation port of the power feeding device.

5. A floating body functioning as a base of an unmanned aerial vehicle
configured to observe environmental information, the floating body comprising:
a power feeding device configured to move in a space below a top surface of the floating body with reference to one of a plurality of planes arranged in a lattice shape on the floating body, roughly specify a position of the unmanned aerial vehicle in two dimensions based on a reflectance of an emitted radio wave, estimate and calculate a power feeding position of the unmanned aerial vehicle based on a reflectance of an output light beam reflected on a reflector attached to a back surface corresponding to a power receiving position of the unmanned aerial vehicle, and feed the unmanned aerial vehicle with power at the power feeding position.

6. An estimation method for estimating a power feeding position,
wherein
in a floating body functioning as a base of an unmanned aerial vehicle configured to observe environmental information, the estimation method enables
a power feeding device configured to move in a space below a top surface of the floating body with reference to one of a plurality of planes arranged in a lattice shape on the floating body and feed the unmanned aerial vehicle with power to perform:
roughly specifying a position of the unmanned aerial vehicle in two dimensions based on a reflectance of an emitted radio wave, and
estimating and calculating a power feeding position of the unmanned aerial vehicle based on a reflectance of an output light beam reflected on a reflector attached to a back surface corresponding to a power receiving position of the unmanned aerial vehicle.

7. A non-transitory computer readable medium storing one or more instructions for executing the estimation method according to claim 6.
